(19) United States
(12) Patent Application Publication
(10) Pub. No.: US 2009/0261225 A1
(43) Pub. Date: Oct. 22, 2009

(54) ILLUMINATING DEVICE

(75) Inventors: GA-LANE CHEN, Santa Clara, CA (US); DA-WEI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/421,711

(22) Filed: Apr. 10, 2009

(30) Foreign Application Priority Data
Apr. 21, 2008 (CN) 200810301224.0

(51) Int. Cl. F16M 13/00

(52) U.S. Cl. 248/422

(57) ABSTRACT

An illuminating device includes a pillar, two parallel toothed poles, a connecting rod, two motors, two gears, a support pole and a light source member. The pillar defines a columnar receiving space extending along an axis direction thereof. The two parallel toothed poles are received in the columnar receiving space and are fixed to the pillar. The connecting rod includes a first end and a second end. The two motors are respectively fixed on the first and second ends of the connecting rod. Each of the two motors includes an main shaft. The two gears are in gear engagement with the two toothed poles respectively, and the two gear are respectively fixed on two main shafts of the two motors such that the two motors are capable of driving the two gears to rotate thereby moving along the toothed poles. The support pole includes a connecting end and a support end, the connecting end is received in the receiving space and connected to the connecting rod. The light source member is attached to the support end of the support pole.

### BACKGROUND

1. Technical Field

The present invention generally relates to illuminating devices, and particularly to an illuminating device suitable for outdoor applications.

2. Discussion of Related Art

Generally, street lamps are mounted on lamp poles. After a long period of outdoor usage, performance of street lamps inevitably deteriorates, and the street lamps may be completely damaged due to many reasons. The damaged street lamps must be repaired or replaced with new lamps. However, street lamps are usually mounted on high lamp poles. Thus, it is inconvenient to repair the street lamps.

What is need, therefore, is a street lamp which is capable of overcoming above problem.

### BRIEF DESCRIPTION OF THE DRAWINGS

Many aspects of the present illuminating device can be better understood with reference to the following drawings. The components in the drawings are not necessarily drawn to scale, the emphasis instead being placed upon clearly illustrating the principles of the present illuminating device.

FIG. 1 is a cross-sectional view of an illuminating device in accordance with an embodiment.

FIG. 2 is similar to FIG. 1, but showing a support pole is lowered.

FIG. 3 is a cross-sectional view of the illuminating device of FIG. 2, taken along a line III-III.

### DETAILED DESCRIPTION OF THE EXEMPLARY EMBODIMENTS

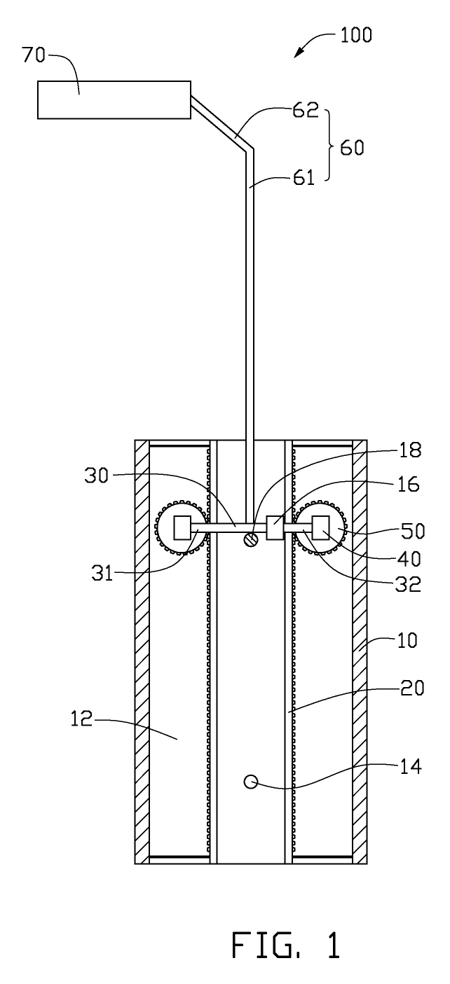

Referring to FIG. 1, an illuminating device 100 includes a pillar 10, two toothed poles 20, a connecting rod 30, two motors 40, two gears 50, a support pole 60 and a light source member 70.

The pillar 10 is annular and an elongated receiving space 12 is defined in the pillar 10. The columnar receiving space 12 extends along an axis direction of the pillar 10. The pillar 10 can be made of stainless steel, aluminum alloy, concrete or wood. A cross section of the receiving space 12 along a direction perpendicular to the axis direction of the pillar 10 can be circular, square, rectangular or polygonal. A first through hole 14 and a second through hole 16 are respectively defined in two ends of the pillar 10, and the two through holes 14, 16 are perpendicular to the axis direction of the pillar 10.

The toothed poles 20 are received in the columnar receiving space 12 and two ends of each of the two toothed poles 20 are fixed to the pillar 10. Each of the two toothed poles 20 includes a number of teeth formed on one side thereof, and the teeth on the two toothed poles 20 face to an inner sidewall of the pillar 10.

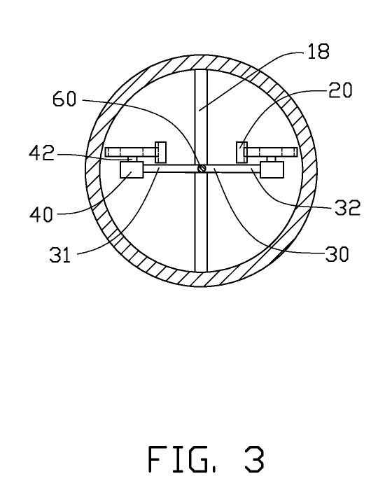

As shown in FIG. 3, the connecting rod 30 includes a first end 31 and a second end 32. The two motors 40 are fixed on the first and second end 31, 32 respectively. Each of the two motor 40 includes a main shaft 42. A central portion of each of the two gears 50 is fixed to an end of a corresponding main shaft 42. Thus, the two motors 40 can drive the two gears 50 to rotate. The two gears 50 are respectively in gear engagement with the two toothed poles 20. As a result, when the two gears 50 rotate, the two gears 50 move along the toothed poles 20 and the connecting rod 30 moves together with the two gears 50. To ensure a synchronization of the movement of the two gears 50, rotating speed of the two motors 40 should be the same, and a rotating direction thereof should be the opposite.

The support pole 60 includes a connecting end 61 and a support end 62. The connecting end 61 is at least partially received in the receiving space 12 and is connected to the connecting rod 30. In the present embodiment, the connecting end 61 is connected to a middle portion of the connecting rod 30. The support pole 60 extends along the axis direction of the pillar 10. The support end 62 is at an angle with the connecting end 61. In general, the axis direction of the pillar 10 is perpendicular to the horizontal direction. Thus, the support end 62 extends in a slope direction. In the present embodiment, a length of connecting end 61 is less than that of the pillar such that the connecting end 61 is capable of being received in the receiving space 12. The light source member 70 is attached to the support end 62. The light source member 70 can be a light emitting diode illuminating device.

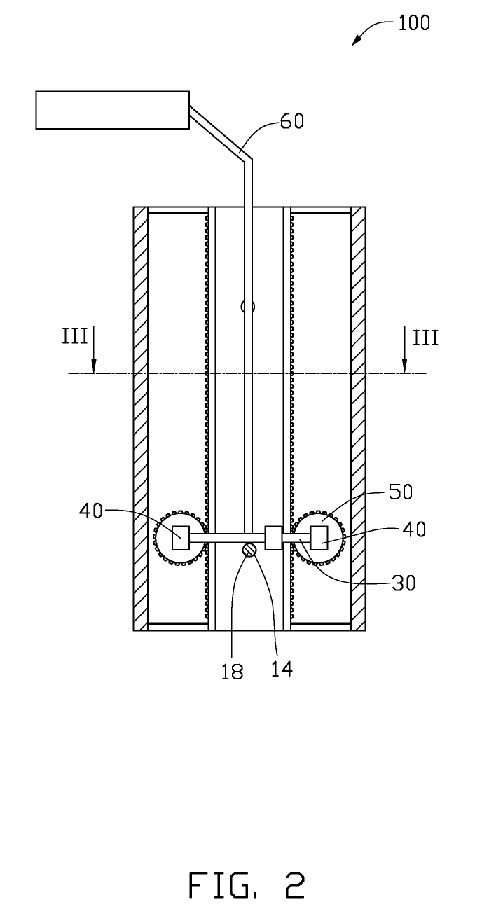

As shown in FIGS. 1 and 3, to reduce the amount of force the two gears 50 apply to the two toothed poles 20, a peg 18 is received in the second through hole 16. The peg 18 supports the connecting rod 30 such that the support pole 60 is maintained at a high position. Referring to FIG. 2, to lower the support pole 60, the peg 18 is pulled out of the second through hole 16, and the two motors 40 is activated to move the two gears 50 to a lower position, for example, above the first through hole 14. The peg 18 can be received in the first through hole 14 for supporting the connecting rod 30 after the connecting rod 30 is lowered.

In the illuminating device 100 of the present embodiment, it is very convenient to lower the support pole 60 and the light source member 70 by driving the two motors 40. Thereby, allowing the light source member to be easy accessed.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. An illuminating device, comprising:
a pillar defining therein an elongated receiving space along a lengthwise direction thereof;
two parallel poles received in the receiving space and fixed to the pillar, each parallel pole including a line of teeth arranged along the lengthwise direction;
a connecting rod comprising a first end and a second end;
two motors respectively fixed on the first and second ends of the connecting rod, each of the motors comprising an main shaft;
two gears respectively meshed with the teeth of the poles, and coupled to the main shafts of the two motors, the two motors configured for driving the two gears to rotate thereby reciprocally moving on and along the poles;
a support pole comprising a connecting portion and a support portion, the connecting portion being received in the receiving space and being connected to the connecting rod; and
a light source attached to the support portion of the support pole.

2. The illuminating device as claimed in claim 1, wherein two through holes are formed in the pillar, each of the through holes being substantially perpendicular to the lengthwise direction of the pillar.

3. The illuminating device as claimed in claim 1, wherein a length of the connecting portion is less than that of the pillar such that the connecting end is capable of being entirely received in the receiving space.

4. The illuminating device as claimed in claim 1, wherein the support portion is obliquely connected with the connecting portion.

5. The illuminating device as claimed in claim 1, wherein two ends of each of the two poles are fixed to the pillar.
